(19) United States
(12) Patent Application Publication
(10) Pub. No.: US 2023/0113529 A1
(43) Pub. Date: Apr. 13, 2023

(54) ENCODING METHOD FOR POINT CLOUD COMPRESSION AND ELECTRONIC DEVICE

(71) Applicant: Industrial Technology Research Institute, Hsinchu (TW)

(72) Inventors: Sheng-Po Wang, Taoyuan City (TW); Ching-Chieh Lin, Taipei City (TW); Jie-Ru Lin, Yilan County (TW); Chun-Lung Lin, Taipei City (TW)

(73) Assignee: Industrial Technology Research Institute, Hsinchu (TW)

(21) Appl. No.: 17/956,841

(22) Filed: Sep. 30, 2022

Related U.S. Application Data
(60) Provisional application No. 63/253,548, filed on Oct. 8, 2021.

(51) Int. Cl. G06T 9/00; H04N 19/147; H04N 19/82; H04N 19/46

(52) U.S. Cl. CPC G06T 9/001; H04N 19/147; H04N 19/82; H04N 19/46

(57) ABSTRACT

An encoding method and an electronic device for point cloud compression are provided. A two-dimensional image and an occupancy map of a point cloud are obtained. An occupancy status of point cloud data of each pixel sample in the two-dimensional image is determined according to the occupancy map. A weight parameter of each pixel sample in an encoding block of the two-dimensional image is determined according to the occupancy statuses of point cloud data of multiple pixel samples. Multiple rate-distortion costs respectively corresponding to multiple encoding operation options are calculated according to the weight parameter of each pixel sample in the encoding block. One of the encoding operation options is determined to be used to perform an encoding operation on the encoding block according to a minimum rate-distortion cost among the rate-distortion costs.

### CROSS-REFERENCE TO RELATED APPLICATION

This application claims the priority benefit of U.S. provisional application Ser. No. 63/253,548, filed on Oct. 8, 2021. The entirety of the above-mentioned patent application is hereby incorporated by reference herein and made a part of this specification.

### BACKGROUND

### Technical Field

The disclosure relates to an encoding method and an electronic device for point cloud compression.

### Description of Related Art

In the prior art, a point cloud is often used to process content in a three-dimensional space. Due to the ability to render an object or a scene, the point cloud may be used in many scenes, such as virtual reality, real-time telepresence, or some other applications. The point cloud is multiple points in the three-dimensional space, and each point has position information, color information, or other information. The amount of data in the point cloud itself is very huge, so effective data compression is very necessary to expand the application range. In the conventional point cloud compression (PCC) technology, an encoder projects point cloud data into multiple patches and integrates the patches into a two-dimensional image, which is beneficial to the application of existing video compression technology. Afterwards, the encoder may generate compressed data according to the two-dimensional image integrated from the patches. The decoder may obtain a patch from the compressed data and reconstruct (or restore) the point cloud from the obtained patch.

However, in order to integrate irregularly shaped patches into a two-dimensional image, the two-dimensional image integrated from the patches is padded with many pixel samples unrelated to the point cloud data itself. As a result, the encoder for point cloud compression wastes a large number of bits to encode the meaningless pixel samples in the two-dimensional image, which will adversely affect the compression performance.

### SUMMARY

In view of the above, the disclosure provides an encoding method and an electronic device for point cloud compression, which can effectively improve the compression performance of point cloud data.

The disclosure provides an encoding method for point cloud compression, which includes the following steps. A two-dimensional image and an occupancy map of a point cloud are obtained. An occupancy status of point cloud data of each pixel sample in the two-dimensional image is determined according to the occupancy map. A weight parameter of each pixel sample in an encoding block of the two-dimensional image is determined according to the occupancy statuses of point cloud data of multiple pixel samples in the two-dimensional image. Multiple rate-distortion (RD) costs respectively corresponding to multiple encoding operation options are calculated according to the weight parameter of each pixel sample in the encoding block. One of the encoding operation options is determined to be used to perform an encoding operation on the encoding block according to a minimum rate-distortion cost among the rate-distortion costs.

The disclosure provides an electronic device, which includes a storage device and a processor. The storage device is recorded with multiple commands. The processor is coupled to the storage device and accesses the command to execute the following steps. A two-dimensional image and an occupancy map of a point cloud are obtained. An occupancy status of point cloud data of each pixel sample in the two-dimensional image is determined according to the occupancy map. A weight parameter of each pixel sample in an encoding block of the two-dimensional image is determined according to the occupancy statuses of point cloud data of multiple pixel samples in the two-dimensional image. Multiple rate-distortion costs respectively corresponding to multiple encoding operation options are calculated according to the weight parameter of each pixel sample in the encoding block. One of the encoding operation options is determined to be used to perform an encoding operation on the encoding block according to a minimum rate-distortion cost among the rate-distortion costs.

Based on the above, the encoding method for point cloud compression according to the embodiment of the disclosure may determine the occupancy status of point cloud data of the pixel samples in the two-dimensional image according to the occupancy map of the point cloud, and determine the weight parameter corresponding to each pixel sample in the encoding block according to the occupancy statuses of point cloud data of the pixel samples. After that, the rate-distortion costs respectively corresponding to the encoding operation options are calculated according to the weight parameter corresponding to each pixel sample in the encoding block, and the encoding operation option corresponding to the minimum rate-distortion cost is determined to be applied to perform the encoding operation on the encoding block. Therefore, the bit number of a compressed bitstream can be effectively saved to improve the compression performance of the point cloud.

### BRIEF DESCRIPTION OF THE DRAWINGS

FIG. 1 is a schematic diagram of a point cloud compression mechanism according to an embodiment of the disclosure.

FIG. 2 is a schematic diagram of an electronic device for point cloud compression according to an embodiment of the disclosure.

FIG. 3 is a flowchart of an encoding method for point cloud compression according to an embodiment of the disclosure.

FIG. 4 is a schematic diagram of an encoding method for point cloud compression according to an embodiment of the disclosure.

FIG. 5 is a schematic diagram of an occupancy mask according to an embodiment of the disclosure.

FIG. 6 is a flowchart of encoding a two-dimensional image according to an embodiment of the disclosure.

FIG. 7 is a flowchart of intra prediction according to an embodiment of the disclosure.

FIG. 8 is a flowchart of inter prediction according to an embodiment of the disclosure.

FIG. 9 is a schematic diagram of setting a quantization parameter according to an embodiment of the disclosure.

FIG. 10 is a flowchart of setting a quantization parameter according to an embodiment of the disclosure.

FIG. 11 is a schematic diagram of performing sample padding processing in loop filtering according to an embodiment of the disclosure.

FIG. 12 is a flowchart of loop filtering processing according to an embodiment of the disclosure.

### DETAILED DESCRIPTION OF DISCLOSED EMBODIMENTS

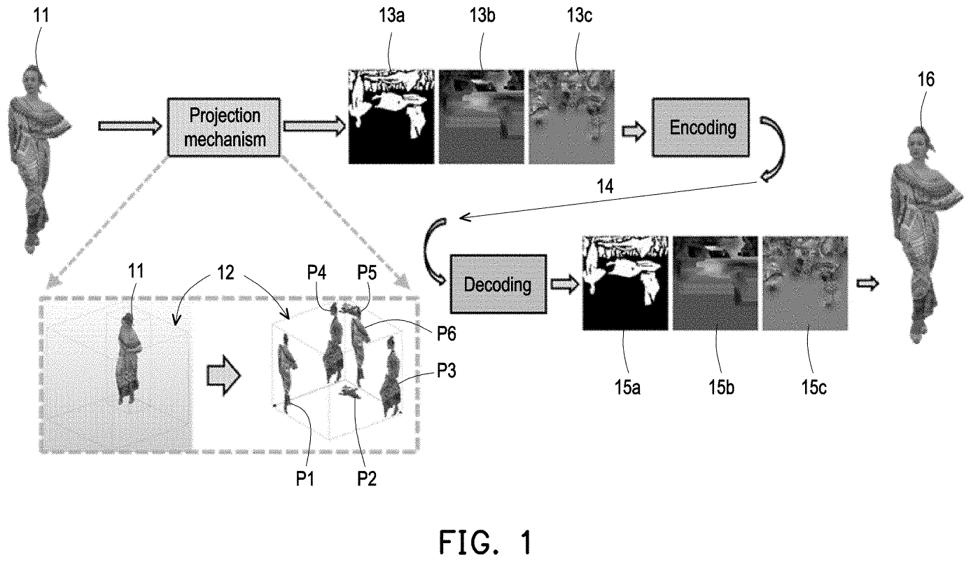

Please refer to FIG. 1, which is a schematic diagram of a point cloud mechanism according to an embodiment of the disclosure. In FIG. 1, a point cloud 11 is a collection of data points in a specific space and may be used to present a three-dimensional object. The point cloud 11 may include multiple points, wherein the points do not necessarily have a specific order and there is not necessarily a specific relationship between the points. In addition, each point in the point cloud 11 has corresponding geometry information (for example, coordinates of the point in a three-dimensional space) and attribute information (for example, color, reflectance, transparency, etc.).

The current point cloud compression technology is to project the point cloud 11 corresponding to the three-dimensional object onto multiple projection planes of a bounding box (BB) 12, thereby forming multiple point cloud patches P1 to P6 on the projection planes. In the embodiment, the bounding box 12 is described by taking a rectangular parallelepiped as an example, but not limited thereto. In FIG. 1, the bounding box 12 includes, for example, 6 projection planes, and each point in the point cloud 11 may be projected onto the corresponding projection plane according to a normal vector thereof, thereby forming the point cloud patches P1 to P6 on the 6 projection planes. Afterwards, through integrating the point cloud patches P1 to P6, an occupancy map 13a and multiple two-dimensional images of the point cloud 11 may be generated. The two-dimensional image may include a geometry map 13b and an attribute map 13c.

In FIG. 1, the occupancy map 13a is, for example, a bitmap including only 1 and 0. The occupancy map 13a may include at least one occupied region (for example, a region consisting of 1) and at least one unoccupied region (for example, a region consisting of 0). The occupied region on the occupancy map 13a is used to represent a region where the point cloud is patched on the two-dimensional image with point cloud data. On the contrary, the unoccupied region on the occupancy map 13a is used to represent a region where the point cloud is patched on the two-dimensional image without the point cloud data. In other words, each occupied region on the occupancy map 13a is used to indicate the corresponding occupied region on the geometry map 13b and the attribute map 13c, and the occupied regions of the geometry map 13b and the attribute map 13c are used to record the geometry information and the attribute information of the corresponding point cloud patches. In addition, when integrating the point cloud patches to generate the two-dimensional image, a dilation algorithm or a padding algorithm may be applied to establish content of a region outside the point cloud patches, so as to maintain the continuity of content of an image.

After that, the encoder may encode the occupancy map 13a, the geometry map 13b, and the attribute map 13c into a bitstream 14 using a video encoding standard. Correspondingly, the decoder may obtain the restored occupancy map 15a, geometry map 15b, and attribute map 15c based on the bitstream 14. After that, the decoder may reconstruct each point cloud patch in the three-dimensional space based on the occupancy map 15a, the geometry map 15b, and the attribute map 15c, and each reconstructed point cloud patch may form a reconstructed point cloud 16. The video encoding standard is, for example, H.264, HEVC, H.266, etc., which is not limited in the disclosure.

It should be noted that in some embodiments, when the two-dimensional image of the point cloud 11 is compressed using the video encoding standard, a split mode, an encoding mode, or other encoding operation options of an encoding block may be determined according to a rate-distortion optimization (RDO) mechanism. Considering that the two-dimensional image of the point cloud 11 has meaningless pixel samples (that is, pixel samples unrelated to the point cloud data), through referring to the occupancy map 13a, the disclosure calculates a rate-distortion (RD) cost based on an occupancy status of point cloud data of each pixel sample in the two-dimensional image. Based on this, the disclosure may ignore the distortion of the meaningless pixel samples, so as to achieve the result of encoding the two-dimensional image of the point cloud using fewer bits, thereby improving the compression performance of the point cloud.

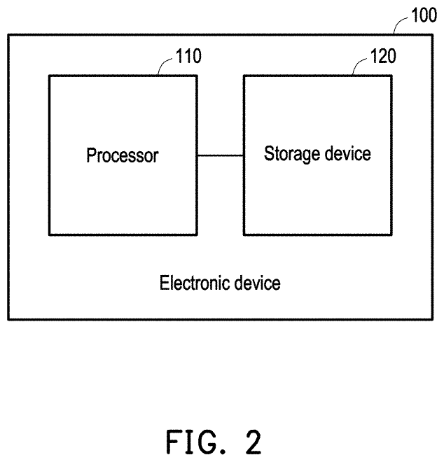

FIG. 2 is a schematic diagram of an electronic device for point cloud compression according to an embodiment of the disclosure. Please refer to FIG. 2. An electronic device 100 may include a processor 110 and a storage device 120.

The processor 110 is, for example, a central processing unit (CPU), other programmable general purpose or specific purpose micro control units (MCU), microprocessors, digital signal processors (DSP), programmable controllers, application specific integrated circuits (ASIC), graphics processing units (GPU), image signal processors (ISP), image processing units (IPU), arithmetic logic units (ALU), complex programmable logic devices (CPLD), field programmable gate arrays (FPGA), other similar elements, or a combination of the above elements. The processor 110 may be coupled to the storage device 120 and may access and execute multiple commands, codes, software modules, or various applications stored in the storage device 120, so as to implement the encoding method for point cloud compression provided by the disclosure, the details of which are detailed below. That is, the electronic device 100 may be regarded as an encoder device.

The storage device 120 is, for example, any type of fixed or removable random-access memory (RAM), read-only memory (ROM), flash memory, hard disk drive (HDD), solid state drive (SSD), similar elements, or a combination of the above elements for storing commands, codes, software modules, or various applications executable by the processor 110.

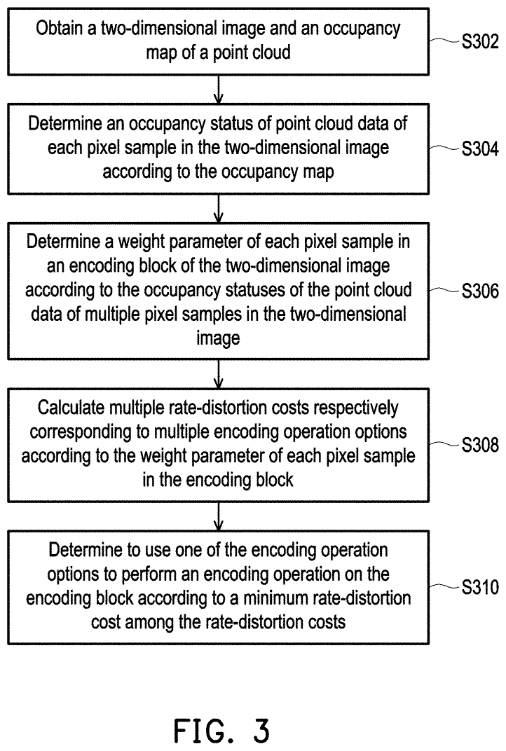

FIG. 3 is a flowchart of an encoding method for point cloud compression according to an embodiment of the disclosure. Please refer to FIG. 3. The method of the embodiment may be executed by the electronic device 100 of FIG. 2, and the details of each step of FIG. 3 will be described below in conjunction with the elements shown in FIG. 2.

In the embodiment, the processor 130 may first project each point in the point cloud onto a corresponding projection plane based on the mechanism shown in FIG. 1 to form multiple point cloud patches, and further generate the occupancy map and the two-dimensional image of the point cloud. Afterwards, the processor 130 may execute the method shown in FIG. 3 on the two-dimensional image using the occupancy map to encode the two-dimensional image including the point cloud patches, and the details of which are detailed below.

First, in Step S302, the processor 110 obtains the two-dimensional image and the occupancy map of the point cloud. The two-dimensional image may include the geometry map or the attribute map of the point cloud.

In Step S304, the processor 110 determines the occupancy status of point cloud data of each pixel sample in the two-dimensional image according to the occupancy map. Specifically, if the occupancy status of point cloud data of a certain pixel sample is an occupied status, it means that the pixel sample is an occupied pixel sample including point cloud patch data. If the occupancy status of point cloud data of a certain pixel sample is an unoccupied status, it means that the pixel sample is an unoccupied pixel sample that does not include the point cloud patch data. In other words, through referring to the occupancy map, the processor 110 may classify each pixel sample in the two-dimensional image as the occupied pixel sample or the unoccupied pixel sample.

In Step S306, the processor 110 determines a weight parameter of each pixel sample in the encoding block of the two-dimensional image according to the occupancy statuses of point cloud data of the pixel samples in the two-dimensional image. The weight parameter of each pixel sample in the encoding block is used to calculate a rate-distortion cost corresponding to different encoding operation options.

In some embodiments, if an occupancy status of point cloud data of a first pixel sample in the two-dimensional image is the occupied status, a weight parameter of the first pixel sample in the encoding block has a first value. On the other hand, if the occupancy status of point cloud data of the first pixel sample in the two-dimensional image is the unoccupied status, the weight parameter of the first pixel sample in the encoding block has a second value. The first value is different from the second value. In some embodiments, the first value is 1 and the second value is 0. Specifically, if the first pixel in the encoding block is the occupied pixel sample related to the point cloud data, the processor 110 may configure the weight parameter of the first pixel to be 1. If the first pixel in the encoding block is the unoccupied pixel sample unrelated to the point cloud data, the processor 110 may configure the weight parameter of the first pixel to be 0.

In Step S308, the processor 110 calculates multiple rate-distortion costs respectively corresponding to multiple encoding operation options according to the weight parameter of each pixel sample in the encoding block. In other words, when an encoding block is to be encoded, the processor 110 may obtain the weight parameter of each pixel sample in the encoding block, and calculate multiple rate-distortion costs respectively corresponding to multiple encoding operation options according to the weight parameter of each pixel sample to obtain the rate-distortion costs respectively corresponding to the encoding operation options.

In some embodiments, the rate-distortion costs may be respectively represented by Formula (1) below.

J=Σᵢ₌₁^{N}Dᵢ×Mᵢ+λR Formula (1)

where J is the rate-distortion cost corresponding to a certain encoding operation option; i is the pixel sample index; N is the number of pixel samples of the encoding block; Mᵢ is the weight parameter of each pixel sample in the encoding block; Dᵢ is the distortion parameter; R is the bit rate of the encoding block; and λ is the Lagrange multiplier.

Finally, in Step S310, the processor 110 determines to use one of the encoding operation options to perform an encoding operation on the encoding block according to a minimum rate-distortion cost among the rate-distortion costs. Specifically, after the processor 110 calculates the rate-distortion costs respectively corresponding to different encoding operation options, the processor 110 may obtain the minimum rate-distortion cost. Next, the processor 110 may determine to use a preferred encoding operation option corresponding to the minimum rate-distortion cost to perform the encoding operation on the encoding block. In other words, in the embodiment of the disclosure, in any application scenario in which the rate-distortion optimization (RDO) mechanism is applied to select the encoding operation option, the processor 110 may calculate the rate-distortion cost with reference to the weight parameter of each pixel sample.

In some embodiments, the encoding operation options may include multiple intra prediction modes, such as 35 types of intra prediction modes specified by the HEVC standard. The 35 types of intra prediction modes may include a DC prediction mode, a planar prediction mode, and 33 types of angle prediction modes. In addition, the encoding operation options may also include split modes under the intra prediction mode, such as 2N*2N and N*N.

In some embodiments, the encoding operation options may include multiple motion vectors in an inter prediction mode. The motion vector may be a motion vector corresponding to integer precision search or a motion vector corresponding to fractional precision search. In addition, the encoding operation options may include split modes under the inter prediction mode, such as 2N*2N, N*N, 2N*N, N*2N, 2N*nU, 2N*nD, nL*2N, and nR*2N.

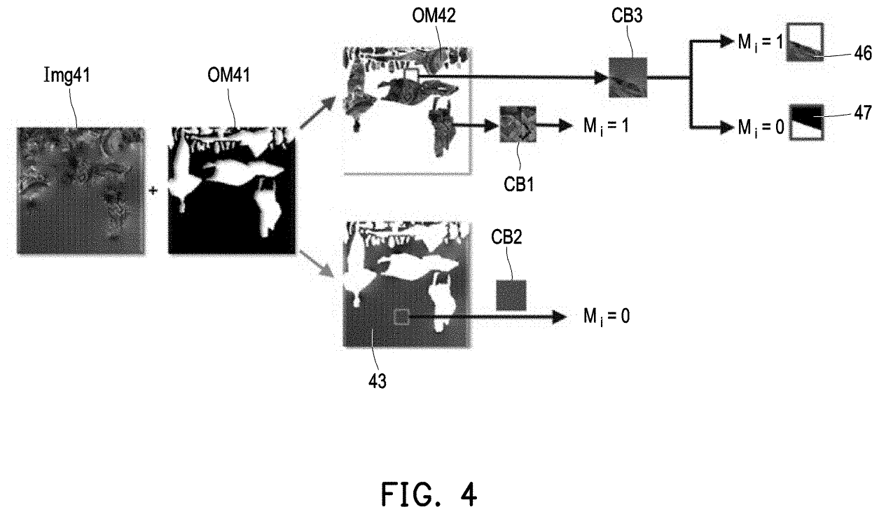

FIG. 4 is a schematic diagram of an encoding method for point cloud compression according to an embodiment of the disclosure. Please refer to FIG. 4. The processor 110 may classify each pixel sample of a two-dimensional image Img41 into an occupied pixel sample 42 and an unoccupied pixel sample 43 according to an occupancy map OM41. In FIG. 4, an occupancy status of point cloud data of each pixel sample in an encoding block CB1 is the occupied status (that is, all the pixel samples in the encoding block CB1 belong to the occupied pixel sample 42). Therefore, the encoding block CB1 may be classified as a fully occupied block, and the processor 110 may set weight parameters Mᵢ of all the pixel samples in the encoding block CB1 to 1. Therefore, when the processor 110 intends to perform compression encoding on the encoding block CB1, the processor 110 may substitute the weight parameter Mᵢ=1 of each pixel sample in the CB1 into Formula (1) to calculate a rate-distortion cost corresponding to each encoding option operation.

In addition, an occupancy status of point cloud data of each pixel sample in an encoding block CB2 is the unoccupied status (that is, all pixel samples in the encoding block CB2 belong to the unoccupied pixel sample 43). Therefore, the encoding block CB1 may be classified as the unoccupied block, and the processor 110 may set the weight parameter Mᵢ of all the pixel samples in the encoding block CB2 to 0. Therefore, when the processor 110 intends to perform compression encoding on the encoding block CB2, the processor 110 may substitute the weight parameter Mᵢ=0 of each pixel sample in the encoding block CB2 into Formula (1) to calculate rate-distortion costs corresponding to different encoding option operations. In other words, when calculating the rate-distortion cost of the encoding block CB2, the processor 110 does not consider the distortion of the unoccupied pixel samples.

It should be noted that in an encoding block CB3, an occupancy status of point cloud data of a partial pixel sample 46 is the occupied status, while an occupancy status of point cloud data of another partial pixel sample 47 is the unoccupied status (that is, in the encoding block CB3, the partial pixel sample 46 belongs to the occupied pixel sample 42 and another partial pixel sample 47 belongs to the unoccupied pixel sample 43). Therefore, the encoding block CB3 may be classified as a partially occupied block. In some embodiments, if an occupancy status of point cloud data of a first pixel sample in the encoding block CB3 is the occupied status, the processor 110 determines that a weight parameter of the first pixel sample in the encoding block CB3 has the first value (for example, 1). If the occupancy status of point cloud data of the first pixel sample in the encoding block CB3 is the unoccupied status, the processor 110 determines that the weight parameter of the first pixel sample in the encoding block CB3 has the second value (for example, 0). Therefore, when the processor 110 intends to perform compression encoding on the encoding block CB3, the processor 110 may substitute the weight parameter Mᵢ=1 of the partial pixel sample 46 and the weight parameter Mᵢ=0 of another partial pixel sample 47 in the CB2 into Formula (1) to calculate rate-distortion costs corresponding to different encoding option operations.

In some embodiments, the processor 110 may classify the encoding block as the fully occupied block (for example, CB1 of FIG. 4), the partially occupied block (for example, CB3 of FIG. 4), or the unoccupied block (for example, CB2 of FIG. 4) according to the occupancy statuses of point cloud data of the pixel samples in the two-dimensional image. If the encoding block is the fully occupied block, the processor 110 may determine the weight parameter of each pixel sample in the encoding block as the first value. If the encoding block is the unoccupied block, the processor 110 may determine the weight parameter of each pixel sample in the encoding block as the second value. The first value is different from the second value. It should be noted that if the encoding block is the partially occupied block, the processor 110 may determine the weight parameter of each pixel sample in the encoding block of the two-dimensional image according to the occupancy status of point cloud data or a sample characteristic of each pixel sample in the encoding block.

For example, in the example of FIG. 4, for the partially occupied block, the processor 110 respectively determines that the weight parameter of each pixel sample is 1 or 0 according to whether each pixel sample in the partially occupied block is the occupied pixel sample or the unoccupied pixel sample. Alternatively, in some embodiments, for the partially occupied block, the processor 110 may determine the weight parameter of each pixel sample according to the sample characteristic of each pixel sample in the encoding block. The sample characteristic includes sample location, sample color, number of occupied pixel samples of an adjacent region, sample gradient, sample depth, or a combination thereof.

In some embodiments, the processor 110 may establish an occupancy mask for indicating the occupancy status of point cloud data of each pixel sample in the two-dimensional image with reference to the occupancy map. Also, the occupancy mask may record an importance flag corresponding to each pixel sample in the two-dimensional image. The occupancy mask may include multiple mask regions. In some embodiments, the importance flag of each pixel sample in a first mask region in the occupancy mask has a first flag value, the importance flag of each pixel sample in a second mask region in the occupancy mask has a second flag value, and the importance flag of each pixel sample in a third mask region in the occupancy mask has a third flag value. In this way, the processor 110 may obtain the importance flag of each pixel sample in the encoding block through referring to the occupancy mask, and determine the weight parameter of each pixel sample according to the importance flag.

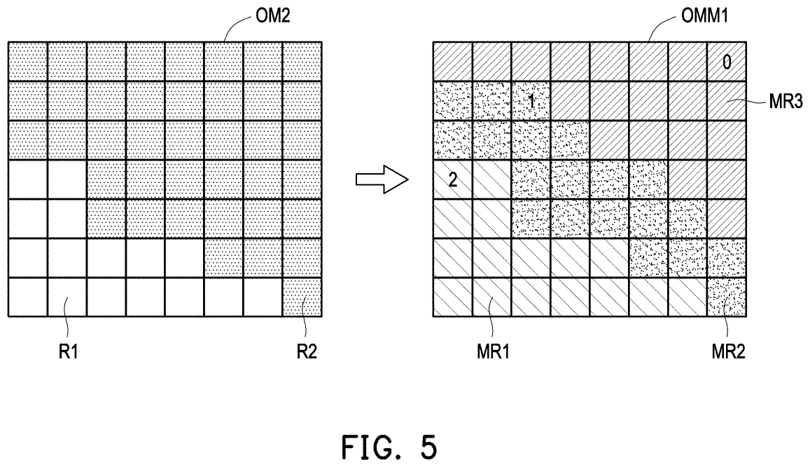

FIG. 5 is a schematic diagram of an occupancy mask according to an embodiment of the disclosure. Please refer to FIG. 5. The processor 110 may generate an occupancy mask OMM1 according to an occupancy map OM2. The occupancy mask OMM1 may include a first mask region MR1, a second mask region MR2, and a third mask region MR3 (the mask regions are respectively shown with different mesh patterns). The occupancy map OM2 includes an occupied region R1 and an unoccupied region R2 (the occupied region and the unoccupied region are respectively shown with different mesh patterns). Correspondingly, the first mask region MR1 corresponds to the occupied region R1, and an importance flag in the first mask region MR1 may be set to the first flag value (for example, 2). In other words, the first mask region MR1 corresponds to a region including the point cloud patch data.

In addition, the second mask region MR2 and the third mask region MR3 of the occupancy mask OMM1 correspond to the unoccupied region R2. The second mask region MR2 is connected between the first mask region MR1 and the third mask region MR3. The second mask region MR2 is located on an edge of the first mask region MR1, and the second mask region MR2 is a region that may be referenced by a prediction block generated in an encoding prediction operation. The region range of the second mask region MR2 may be configured according to practical applications, which is not limited in the disclosure. An importance flag in the second mask region MR2 may be set to the second flag value (for example, 1). An importance flag in the third mask region MR3 may be set to the third flag value (for example, 0).

Therefore, through referring to the occupancy mask OMM1, the processor 110 may obtain the weight parameter of each pixel sample in the two-dimensional image. In some embodiments, when an importance flag of a certain pixel sample is 2 (flag=2), the processor 110 may set a weight parameter of the pixel sample to 1. When an importance flag of a certain pixel sample is 1 or 0 (flag=1 or 0), the processor 110 may set a weight parameter of the pixel sample to 0.

In some embodiments, the importance flag of each pixel sample may be used not only to determine the weight parameter, but also to determine a quantization parameter or a residual information reserve of an encoding process. In other words, the disclosure may not only select the encoding operation option by considering the occupancy status of point cloud data of the pixel sample, but also determine the quantization parameter or the residual information reserve for quantizing a transform coefficient by considering the occupancy status of point cloud data of the pixel sample. Embodiments will be exemplified below for illustration.

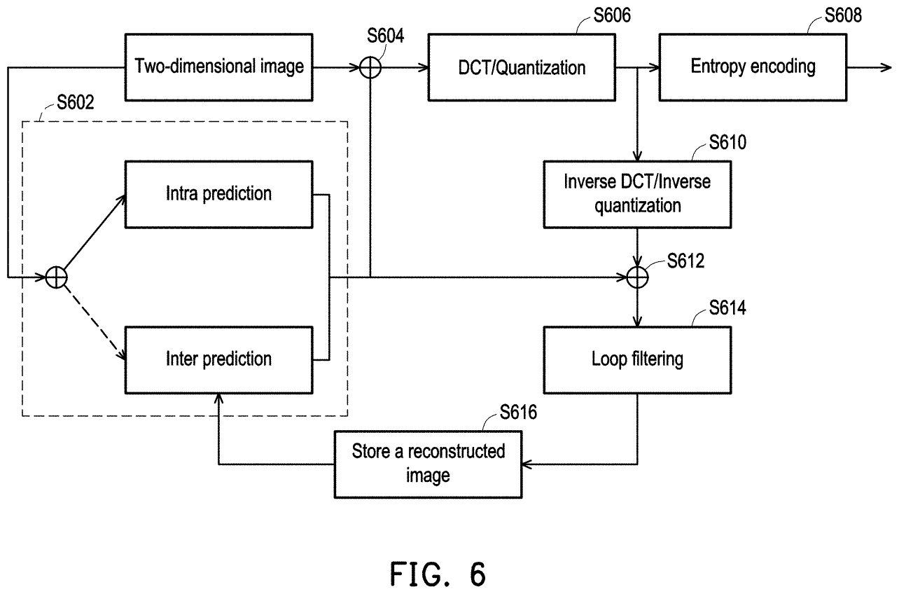

FIG. 6 is a flowchart of encoding a two-dimensional image according to an embodiment of the disclosure. The processor 110 may split the two-dimensional image of the point cloud into multiple encoding blocks. Please refer to FIG. 6. In Step S602, the processor 110 may perform intra prediction or inter prediction of the encoding block to generate a prediction block.

In some embodiments, the encoding operation option may include multiple prediction modes. When executing the intra prediction or the inter prediction of the encoding block (Step S602), the processor 110 may perform precoding processing using multiple prediction modes, so as to obtain the rate-distortion cost corresponding to each prediction mode according to Formula (1). The prediction modes may include multiple inter prediction modes and/or multiple intra prediction modes. Therefore, the processor 110 may select a minimum rate-distortion cost from the obtained rate-distortion costs, and determine the prediction mode corresponding to the minimum rate-distortion cost as a preferred prediction mode of the current encoding block. Afterwards, the processor 110 may perform the intra prediction or the inter prediction on the encoding block according to the preferred prediction mode determined based on the rate-distortion costs.

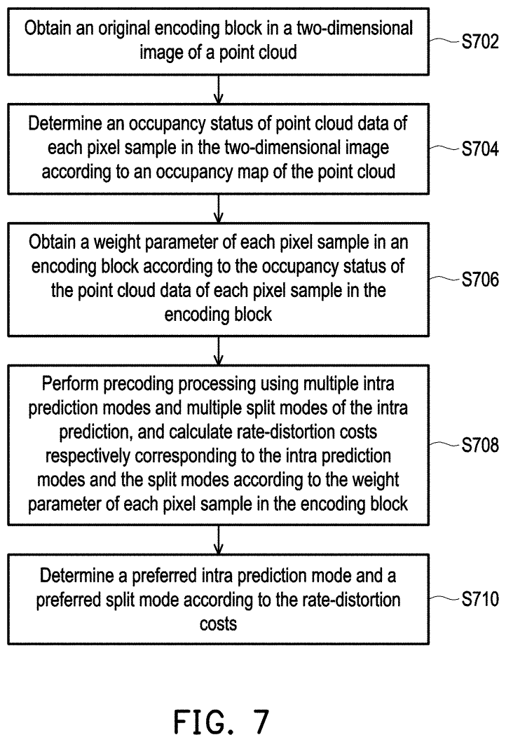

FIG. 7 is a flowchart of intra prediction according to an embodiment of the disclosure. Please refer to FIG. 7. In Step S702, the processor 110 obtains an original encoding block in the two-dimensional image of the point cloud. In Step S704, the processor 110 may determine the occupancy status of point cloud data of each pixel sample in the two-dimensional image according to the occupancy map of the point cloud. In Step S706, the processor 110 may obtain the weight parameter of each pixel sample in the encoding block according to the occupancy status of point cloud data of each pixel sample in the encoding block. In Step S708, the processor 110 may perform the precoding processing using multiple intra prediction modes and multiple split modes of the intra prediction, and calculate the rate-distortion costs respectively corresponding to the intra prediction modes and the split modes according to the weight parameter of each pixel sample in the encoding block. In detail, the processor 110 may generate corresponding prediction blocks using the intra prediction modes and the split modes of the intra prediction, and calculate the corresponding rate-distortion costs according to the difference between the prediction blocks and an actual value of the encoding block and the weight parameter of each pixel sample. In Step S710, the processor 110 may determine a preferred intra prediction mode and a preferred split mode according to the rate-distortion costs.

For example, the processor 110 may determine a preferred angle prediction mode using Formula (2).

$${min}_{P = direction} J = {\sum }_{i = 1}^{N} ( {SATD}_{i} \times {M}_{i} ) + {λ}_{direction} \times R \qquad Formula ( 2 )$$

where J is the rate-distortion cost corresponding to multiple angle prediction modes; i is the pixel sample index; N is the number of pixel samples of the encoding block; Mᵢ is the weight parameter of each pixel sample in the encoding block; SATDᵢ is the distortion parameter; R is the bit rate of the encoding block; and λ is the Lagrange multiplier. Here, the calculation manner of the distortion parameter may be implemented as the sum of absolute transformed differences (SATD).

In some embodiments, during the process of executing the intra prediction, when an importance flag corresponding to a certain reference pixel sample adjacent to the encoding block is 1 or 0, the processor 110 may set the reference pixel sample to be unavailable. When a certain reference pixel sample is set to be unavailable, the processor 110 searches for other available reference pixel samples for the intra prediction or executes a reference pixel substitution process.

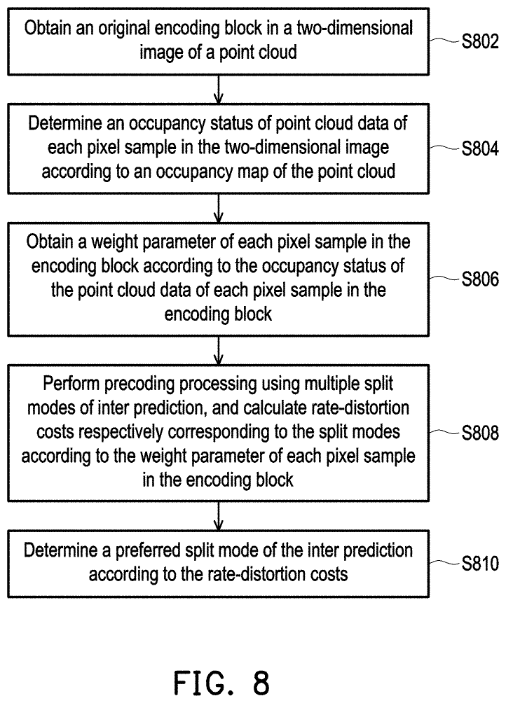

FIG. 8 is a flowchart of inter prediction according to an embodiment of the disclosure. Please refer to FIG. 8. In Step S802, the processor 110 obtains an original encoding block in the two-dimensional image of the point cloud. In Step S804, the processor 110 may determine the occupancy status of point cloud data of each pixel sample in the two-dimensional image according to the occupancy map of the point cloud. In Step S806, the processor 110 may obtain the weight parameter of each pixel sample in the encoding block according to the occupancy status of point cloud data of each pixel sample in the encoding block. In Step S808, the processor 110 may perform precoding processing using multiple split modes of the inter prediction, and calculate the rate-distortion costs respectively corresponding to the split modes according to the weight parameter of each pixel sample in the encoding block. In detail, the processor 110 may generate corresponding prediction blocks using the split modes of the inter prediction, and calculate the corresponding rate-distortion costs according to the difference between the prediction blocks and an actual value of the encoding block and the weight parameter of each pixel sample. In Step S810, the processor 110 may determine a preferred split mode of the inter prediction according to the rate-distortion costs. The split modes of the inter prediction may include 2N*2N, N*N, 2N*N, N*2N, 2N*nU, 2N*nD, nL*2N, and nR*2N.

In addition, in some embodiments, the processor 110 may also determine a motion vector of the inter prediction according to the rate-distortion cost applying the weight parameter. Specifically, when the processor 110 searches for a matching reference block in a reference image to determine the motion vector, the processor 110 may calculate the difference between multiple candidate blocks and the current encoding block to calculate the rate-distortion costs corresponding to multiple motion vectors. Alternatively, in some embodiments, the processor 110 may also determine the reference image of the inter prediction according to the rate-distortion cost applying the weight parameter.

For example, the processor 110 may determine a preferred motion vector in integer precision using Formula (3).

$${min}_{P = {MV}_{int}} J = {\sum }_{i = 1}^{N} ( {SAD}_{i} \times {M}_{i} ) + {λ}_{{MV}_{int}} \times R \qquad Formula ( 3 )$$

where J is the rate-distortion cost corresponding to multiple motion vectors MVᵢₙₜ; i is the pixel sample index; N is the number of pixel samples of the encoding block; Mᵢ is the weight parameter of each pixel sample in the encoding block; SADᵢ is the distortion parameter; R is the bit rate of the encoding block; and λ is the Lagrange multiplier. Here, the calculation manner of the distortion parameter of Formula (3) may be implemented as the sum of absolute differences (SAD).

In addition, the processor 110 may determine the preferred motion vector in fractional precision using Formula (4).

$${min}_{P = {MV}_{fra}} J = {\sum }_{i = 1}^{N} ( {SATD}_{i} \times {M}_{i} ) + {λ}_{{MV}_{fra}} \times R \qquad Formula ( 4 )$$

where J is the rate-distortion cost corresponding to multiple motion vectors MV_{fra}; i is the pixel sample index; N is the number of pixel samples of the encoding block; Mᵢ is the weight parameter of each pixel sample in the encoding block; SADᵢ is the distortion parameter; R is the bit rate of the encoding block; and λ is the Lagrange multiplier. Here, the calculation manner of the distortion parameter of Formula (4) may be implemented as the sum of absolute differences of the Hadamard transform. Through the calculation of Formula (3) and Formula (4), the processor 110 may obtain a preferred motion vector of the current encoding block.

Returning to FIG. 6, in Step S604, the processor 110 may subtract the prediction block and an actual data block of the two-dimensional image to obtain a residual block. In Step S606, the processor 110 may perform DCT and quantization on the residual block to generate a quantized transform coefficient. Furthermore, in some embodiments, the processor 110 may determine the size of a quantization step (QStep) using a quantization parameter (QP). The quantization parameter has a positive correlation with the quantization step. The smaller the quantization step, the better the image quality, but the worse the compression ratio. The larger the quantization step, the worse the image quality, but the better the compression ratio. The processor 110 may quantize the transform coefficient according to the quantization step corresponding to the quantization parameter. Furthermore, in some embodiments, the processor 110 may determine a quantization matrix using the quantization parameter, and quantize the transform coefficient using the quantization matrix.

As described in the foregoing embodiments, the disclosure may set the importance flag and the weight parameter of the pixel sample according to the occupancy map, so as to calculate the rate-distortion costs of different encoding operation options according to the weight parameter of the pixel sample. In some embodiments, the disclosure may also determine the processing manner of the residual block according to the importance flag of the pixel sample.

In some embodiments, the processor 110 may determine the quantization parameter according to respective importance flags of multiple pixel samples in the encoding block. The quantization parameter is used to quantize the transform coefficient of a transform unit. The processor 110 may determine the number of reserved coefficients of the transform unit according to the importance flag of each pixel sample in the encoding block.

In some embodiments, if the importance flags of all the pixel samples in the encoding block have the first flag value (for example, 2) or the second flag value (for example, 1), the processor 110 may quantify a residual value of the encoding block using a first quantization parameter, and reserve M transform coefficients. If the importance flags of all the pixel samples in the encoding block have the third flag value (for example, 0), the processor 110 may quantize the residual value of the encoding block using a second quantization parameter, and reserve N transform coefficients. The second quantization parameter is greater than the first quantization parameter, where M and N are positive integers, and M is greater than N.

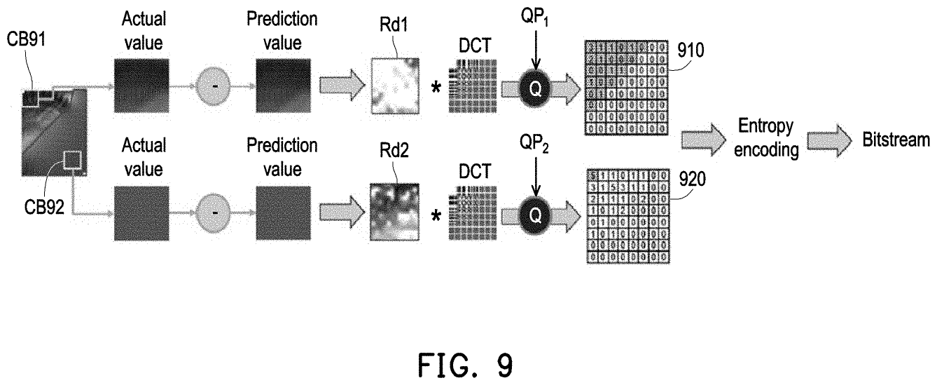

For example, FIG. 9 is a schematic diagram of setting a quantization parameter according to an embodiment of the disclosure. Please refer to FIG. 9. A residual block Rd1 corresponds to an encoding block CB91. Through referring to the occupancy mask, the processor 110 may confirm that importance flags of all pixel samples in the encoding block CB91 are 2, that is, all the pixel samples in the encoding block CB91 are occupied pixel samples. In other words, the residual block Rd1 corresponds to the first mask region in the occupancy mask, that is, corresponds to the occupied region in the occupancy map. Therefore, after performing DCT on the residual block Rd1, the processor 110 may quantize the transform coefficient using a first quantization parameter QP₁ according to the importance flag of each pixel sample in the encoding block CB91, thereby obtaining a quantized transform block 910. The transform block 910 may include multiple quantized transform coefficients. Afterwards, the processor 110 may reserve the M transform coefficients from the transform block 910 for entropy encoding. In FIG. 9, the reserved transform coefficients are labelled by the dot grid mesh pattern, where M is equal to 21.

On the other hand, a residual block Rd2 corresponds to an encoding block CB92. Through referring to the occupancy mask, the processor 110 may confirm that importance flags of all pixel samples in the encoding block CB92 are 0, that is, all the pixel samples in the encoding block CB91 are unoccupied pixel samples. In other words, the residual block Rd1 corresponds to the third mask region in the occupancy mask, that is, corresponds to the unoccupied region in the occupancy map. Therefore, after performing DCT on the residual block Rd2, the processor 110 may quantize the transform coefficient using a second quantization parameter QP₂ according to the importance flag of each pixel sample in the encoding block CB92, thereby obtaining a quantized transform block 920. The transform block 920 may include multiple quantized transform coefficients. Afterwards, the processor 110 may reserve the N transform coefficients from the transform block 920 for entropy encoding. In FIG. 9, N is equal to 1. In other words, for unimportant pixel samples in the two-dimensional image of the point cloud, the processor 110 may encode with a larger quantization parameter and less residual information, thereby saving the number of encoding bits.

In addition, in some embodiments, if the encoding block includes multiple pixel samples corresponding to the first flag value “2”, the second flag value “1”, and the third flag value “0” at the same time, the processor 110 may determine the quantization parameter according to the sample characteristic. The sample characteristic includes sample location, sample color, number of occupied pixel samples of an adjacent region, sample gradient, sample depth, or a combination thereof. Alternatively, in some embodiments, if the encoding block is the partially occupied block, the processor 110 may determine the quantization parameter according to a statistical result of the importance flags of the pixel samples.

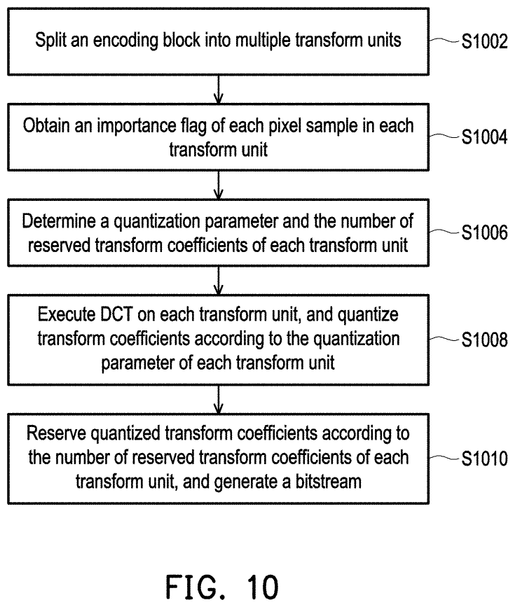

FIG. 10 is a flowchart of setting a quantization parameter according to an embodiment of the disclosure. Please refer to FIG. 10, in Step S1002, the processor 110 splits the encoding block into multiple transform units. In Step S1004, through referring to the occupancy mask generated according to the occupancy map, the processor 110 obtains an importance flag of each pixel sample in each transform unit. In Step S1006, the processor 110 determines a quantization parameter and the number of reserved transform coefficients of each transform unit according to the importance flag of each pixel sample in each transform unit. In Step S1008, the processor 110 executes DCT on each transform unit, and quantizes transform coefficients according to the quantization parameter of each transform unit. In Step S1010, the processor 110 reserves quantized transform coefficients according to the number of reserved transform coefficients of each transform unit, and generates a bitstream accordingly.

Returning to FIG. 6, in Step S608, the processor 110 may perform entropy encoding on the quantized transform coefficients to generate the bitstream. In addition, in Step S610, the processor 110 may perform inverse quantization and inverse transform on the quantized transform coefficients to generate a reconstructed residual block. In Step S612, the processor 110 adds the reconstructed residual block and the prediction block to generate a reconstructed block. In Step S614, the processor 110 may perform loop filtering on the reconstructed block. The loop filtering may include deblocking filtering, sample adaptive offset (SAO) filtering, adaptive loop filtering (ALF), and other types of noise suppression filtering. In Step S616, the processor 110 may store the reconstructed block after the loop filtering into a decoded image buffer to serve as a reference image for executing the inter prediction of the next frame of the two-dimensional image.

In some embodiments, during period of executing loop filtering processing, the processor 110 may perform sample padding processing on multiple unoccupied pixel samples in a reconstructed image of the two-dimensional image according to the occupancy statuses of point cloud data of the pixel samples in the two-dimensional image. The processor 110 may perform the loop filtering processing on the reconstructed image after the sample padding processing. In this way, it is possible to avoid using an excessively distorted pixel sample for performing the loop filtering processing. In detail, when the processor 110 is to perform the loop filtering on the reconstructed image, the processor 110 may obtain a specific filter region that spans the occupied region and the unoccupied region according to the occupancy statuses of point cloud data of the pixel samples in the two-dimensional image and the size of a filter mask. The specific filter region includes multiple unoccupied pixel samples. Here, the processor 110 replaces the unoccupied pixel sample in the specific filter region using the occupied pixel sample in the reconstructed image.

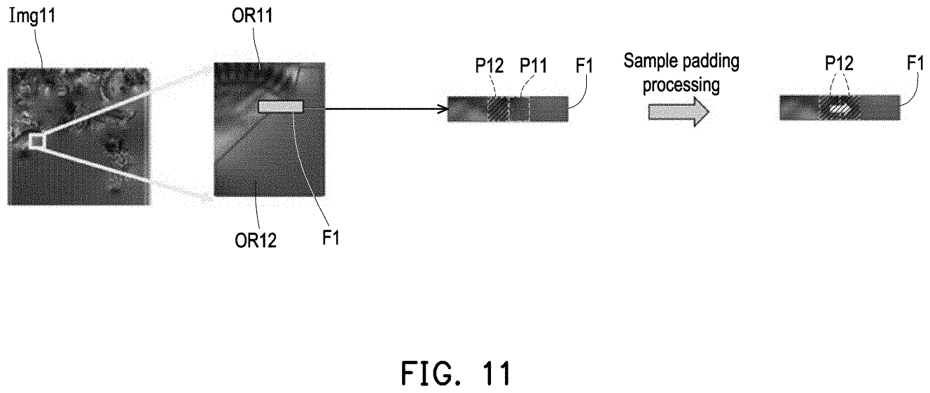

For example, FIG. 11 is a schematic diagram of performing sample padding processing in loop filtering according to an embodiment of the disclosure. Please refer to FIG. 11. When the processor 110 is to perform the loop filtering on a reconstructed image Img11, the processor 110 may obtain a specific filter region F1 that spans an occupied region OR11 and an unoccupied region OR12. The specific filter region F1 includes multiple unoccupied pixel samples P11. Here, the processor 110 replaces the unoccupied pixel sample P11 in the specific filter region F1 using an occupied pixel sample P12 in the reconstructed image Img11. Afterwards, the processor 110 may perform the loop filtering processing on the reconstructed image after the sample padding processing.

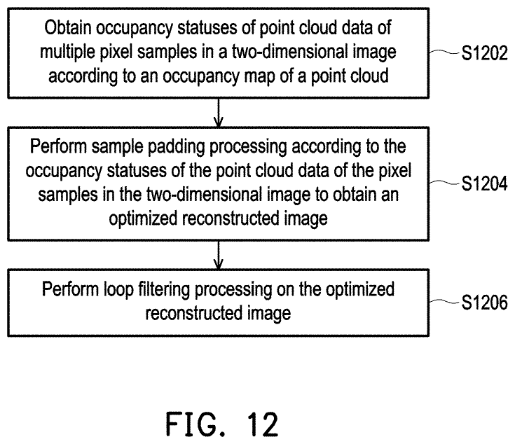

FIG. 12 is a flowchart of loop filtering processing according to an embodiment of the disclosure. Please refer to FIG. 12. In Step S1202, the processor 110 may obtain the occupancy statuses of point cloud data of the pixel samples in the two-dimensional image according to the occupancy map of the point cloud. From another point of view, the processor 110 may obtain the occupancy mask according to the occupancy map of the point cloud. After that, in Step S1204, the processor 110 may perform the sample padding processing according to the occupancy statuses of point cloud data of the pixel samples in the two-dimensional image to obtain an optimized reconstructed image. After that, in Step S1206, the processor 110 may perform the loop filtering processing on the optimized reconstructed image.

In summary, the encoding method for point cloud compression according to the embodiment of the disclosure may obtain the occupancy statuses of point cloud data of the pixel samples in the two-dimensional image according to the occupancy map of the point cloud, and may set the weight parameters of the pixel samples in the two-dimensional image according to the occupancy statuses of point cloud data. Later, when calculating the rate-distortion cost for selecting the encoding operation option, the weight parameter of the pixel sample may be substituted into the calculation. Therefore, the disclosure may ignore the distortion of unoccupied pixels for encoding, thereby saving the number of encoding bits. In addition, the importance flag of the pixel sample may be determined according to the occupancy status of point cloud data, and the quantization parameter and the residual information reserve used during the encoding operation process may also be determined according to the importance flag of the pixel sample. In this way, the disclosure can further save the number of encoding bits, thereby improving the encoding efficiency of the point cloud.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An encoding method for point cloud compression, comprising:
obtaining a two-dimensional image and an occupancy map of a point cloud;
determining an occupancy status of point cloud data of each pixel sample in the two-dimensional image according to the occupancy map;
determining a weight parameter of each pixel sample in an encoding block of the two-dimensional image according to the occupancy statuses of point cloud data of a plurality of pixel samples in the two-dimensional image;
calculating a plurality of rate-distortion (RD) costs respectively corresponding to a plurality of encoding operation options according to the weight parameter of each pixel sample in the encoding block; and
determining to use one of the encoding operation options to perform an encoding operation on the encoding block according to a minimum rate-distortion cost among the rate-distortion costs.

2. The encoding method for point cloud compression according to claim 1, wherein if the occupancy status of point cloud data of a first pixel sample in the two-dimensional image is an occupied status, the weight parameter of the first pixel sample in the encoding block has a first value; and if the occupancy status of point cloud data of the first pixel sample in the two-dimensional image is an unoccupied status, the weight parameter of the first pixel sample in the encoding block has a second value.

3. The encoding method for point cloud compression according to claim 1, wherein the step of determining the weight parameter of each pixel sample in the encoding block of the two-dimensional image according to the occupancy statuses of point cloud data of the pixel samples in the two-dimensional image comprises:
classifying the encoding block as a fully occupied block, a partially occupied block, or an unoccupied block according to the occupancy statuses of point cloud data of the pixel samples in the two-dimensional image;
determining the weight parameter of each pixel sample in the encoding block to be the first value if the encoding block is the fully occupied block;
determining the weight parameter of each pixel sample in the encoding block to be the second value if the encoding block is the unoccupied block, wherein the first value is different from the second value; and
determining the weight parameter of each pixel sample in the encoding block of the two-dimensional image according to the occupancy status of point cloud data or a sample characteristic of each pixel sample in the encoding block if the encoding block is the partially occupied block.

4. The encoding method for point cloud compression according to claim 3, wherein the first value is 1 and the second value is 0.

5. The encoding method for point cloud compression according to claim 3, wherein the step of determining the weight parameter of each pixel sample in the encoding block of the two-dimensional image according to the occupancy status of point cloud data or the sample characteristic of each pixel sample in the encoding block if the encoding block is the partially occupied block comprises:
determining the weight parameter of a first pixel sample in the encoding block to be the first value if the occupancy status of point cloud data of the first pixel sample in the encoding block is an occupied status; and
determining the weight parameter of the first pixel sample in the encoding block to be the second value if the occupancy status of point cloud data of the first pixel sample in the encoding block is an unoccupied status.

6. The encoding method for point cloud compression according to claim 3, wherein the sample characteristic comprises sample location, sample color, number of occupied pixel samples of an adjacent region, sample gradient, sample depth, or a combination thereof.

7. The encoding method for point cloud compression according to claim 1, further comprising:
establishing an occupancy mask for indicating the occupancy status of point cloud data of each pixel sample in the two-dimensional image with reference to the occupancy map,
wherein the occupancy mask records an importance flag corresponding to each pixel sample in the two-dimensional image, and the occupancy mask comprises a plurality of mask regions.

8. The encoding method for point cloud compression according to claim 7, further comprising:
determining a quantization parameter according to the respective importance flags of a plurality of pixel samples in the encoding block, wherein the quantization parameter is used to quantize a transform coefficient of the transform unit; and
determining a number of reserved coefficients of the transform unit according to the importance flag of each pixel sample in the transform unit of the encoding block.

9. The encoding method for point cloud compression according to claim 1, further comprising:
performing sample padding processing on a plurality of unoccupied pixel samples in a reconstructed image of the two-dimensional image according to the occupancy statuses of point cloud data of a plurality of pixel samples in the two-dimensional image during a period of executing loop filtering processing; and
performing the loop filtering processing on the reconstructed image after the sample padding processing.

10. The encoding method for point cloud compression according to claim 1, wherein the rate-distortion costs are respectively represented as:
$$J = {\sum }_{i = 1}^{N} {D}_{i} \times {M}_{i} + λ R$$
where J is the rate-distortion costs, i is a pixel sample index, N is a number of pixel samples, Mᵢ is the weight parameter, Dᵢ is a distortion parameter, R is a bit rate of the encoding block, and λ is a Lagrange multiplier.

11. An electronic device for point cloud compression, comprising:
a storage device, storing a plurality of commands; and
a processor, coupled to the storage device, accessing and executing the commands, and configured to:
obtain a two-dimensional image and an occupancy map of a point cloud;
determine an occupancy status of point cloud data of each pixel sample in the two-dimensional image according to the occupancy map;
determine a weight parameter of each pixel sample in an encoding block of the two-dimensional image according to the occupancy statuses of point cloud data of a plurality of pixel samples in the two-dimensional image;
calculate a plurality of rate-distortion costs respectively corresponding to a plurality of encoding operation options according to the weight parameter of each pixel sample in the encoding block; and
determine to use one of the encoding operation options to perform an encoding operation on the encoding block according to a minimum rate-distortion cost among the rate-distortion costs.

12. The electronic device for point cloud compression according to claim 11, wherein if the occupancy status of point cloud data of a first pixel sample in the two-dimensional image is an occupied status, the weight parameter of the first pixel sample in the encoding block has a first value; and if the occupancy status of point cloud data of the first pixel sample in the two-dimensional image is an unoccupied status, the weight parameter of the first pixel sample in the encoding block has a second value.

13. The electronic device for point cloud compression according to claim 11, wherein the processor is configured to:
classify the encoding block as a fully occupied block, a partially occupied block, or an unoccupied block according to the occupancy statuses of point cloud data of the pixel samples in the two-dimensional image;
determine the weight parameter of each pixel sample in the encoding block to be the first value if the encoding block is the fully occupied block;
determine the weight parameter of each pixel sample in the encoding block to be the second value if the encoding block is the unoccupied block, wherein the first value is different from the second value; and
determine the weight parameter of each pixel sample in the encoding block of the two-dimensional image according to the occupancy status of point cloud data or a sample characteristic of each pixel sample in the encoding block if the encoding block is the partially occupied block.

14. The electronic device for point cloud compression according to claim 13, wherein the first value is 1 and the second value is 0.

15. The electronic device according to claim 13, wherein the processor is configured to:
determine the weight parameter of a first pixel sample in the encoding block to be the first value if the occupancy status of point cloud data of the first pixel sample in the encoding block is an occupied status; and
determine the weight parameter of the first pixel sample in the encoding block to be the second value if the occupancy status of point cloud data of the first pixel sample in the encoding block is an unoccupied status.

16. The electronic device for point cloud compression according to claim 13, wherein the sample characteristic comprises sample location, sample color, number of occupied pixel samples of an adjacent region, sample gradient, sample depth, or a combination thereof.

17. The electronic device for point cloud compression according to claim 11, wherein the processor is configured to:
establish an occupancy mask for indicating the occupancy status of point cloud data of each pixel sample in the two-dimensional image with reference to the occupancy map,
wherein the occupancy mask records an importance flag corresponding to each pixel sample in the two-dimensional image, and the occupancy mask comprises a plurality of mask regions.

18. The electronic device for point cloud compression according to claim 17, wherein the processor is configured to:
determine a quantization parameter according to the respective importance flags of a plurality of pixel samples in the encoding block, wherein the quantization parameter is used to quantize a transform coefficient of the transform unit; and
determine a number of reserved coefficients of the transform unit according to the importance flag of each pixel sample in the transform unit of the encoding block.

19. The electronic device for point cloud compression according to claim 11, wherein the processor is configured to:
perform sample padding processing on a plurality of unoccupied pixel samples in a reconstructed image of the two-dimensional image according to the occupancy statuses of point cloud data of a plurality of pixel samples in the two-dimensional image during a period of executing loop filtering processing; and
perform the loop filtering processing on the reconstructed image after the sample padding processing.

20. The electronic device for point cloud compression according to claim 11, wherein the rate-distortion costs are respectively represented as:
$$J = {\sum }_{i = 1}^{N} {D}_{i} \times {M}_{i} + λ R$$
where J is the rate-distortion costs, i is a pixel sample index, N is a number of pixel samples, Mᵢ is the weight parameter, Dᵢ is a distortion parameter, R is a bit rate of the encoding block, and λ is a Lagrange multiplier.
